(19) United States
(12) Patent Application Publication
(10) Pub. No.: US 2025/0319443 A1
(43) Pub. Date: Oct. 16, 2025

(54) METHOD FOR MANUFACTURING A THIN-FILM COMPOSITE MEMBRANE FOR WATER TREATMENT, HAVING EXTREME ACID AND ALKALINE STABILITY

(71) Applicant: KOREA UNIVERSITY RESEARCH AND BUSINESS FOUNDATION, Seoul (KR)

(72) Inventors: Jung Hyun LEE, Seoul (KR); Sung Kwon JEON, Bucheon-si (KR); Ju Yeon CHOI, Paju-Si (KR); Han Soo KIM, Seongnam-si (KR)

(73) Assignee: KOREA UNIVERSITY RESEARCH AND BUSINESS FOUNDATION, Seoul (KR)

(21) Appl. No.: 18/868,486

(22) PCT Filed: May 25, 2023
(86) PCT No.: PCT/KR2023/007154

§ 371 Date: Nov. 22, 2024

(30) Foreign Application Priority Data
May 25, 2022 (KR) 10-2022-0063993

(51) Int. Cl. B01D 69/12; B01D 67/00; B01D 69/02; B01D 69/10; B01D 71/60; C02F 1/44

(52) U.S. Cl. CPC B01D 69/1251; B01D 67/0006; B01D 67/0095; B01D 69/02; B01D 69/105; B01D 69/107; B01D 71/60; C02F 1/44; B01D 2325/16; B01D 2325/28; B01D 2325/34; B01D 2325/36

(57) ABSTRACT

The present invention relates to a thin-film composite membrane for water treatment and a method for manufacturing same. The selective layer of the thin-film composite membrane according to the present invention is based on a cross-linked quaternary ammonium polymer with high hydrolysis resistance, and thus, excellent stability in both extremely acidic and alkaline conditions may be provided. In addition, the surface of the thin-film composite membrane according to the present invention is positively charged and thus can have high rejection and selectivity for cationic solutes.

### TECHNICAL FIELD

The present invention relates to a method for manufacturing a thin-film composite membrane for water treatment, having extreme acid and alkaline stability.

### BACKGROUND ART

Water treatment technologies using membranes, such as nanofiltration and reverse osmosis, are technologies that remove unwanted solutes while permeating water through the membrane under pressurized conditions. These technologies are widely used in water treatment and desalination due to their higher energy efficiency compared with other methods.

Commercialized membranes for water treatment are made in the form of thin-film composite membranes in which a selective layer that determines separation performance and functionality is combined with a porous polymer support. The selective layer mainly utilizes polyamide that is produced on a support through interfacial polymerization between an amine-based monomer, such as m-phenylenediamine (MPD) or piperazine (PIP), and an acyl chloride-based monomer, such as trimesoyl chloride (TMC), which are dissolved in two immiscible solvents (Patent Document 1).

Recently, there is a growing demand for the thin-film composite membrane that can treat wastewater and effluent in extremely acidic and alkaline environments. However, existing polyamide-based thin-film composite membranes are hydrolyzed in extremely acidic and alkaline environments and thus cannot be used under extremely acidic and alkaline conditions. In addition, due to their high molecular density or negative surface charge characteristics, polyamide-based thin-film composite membranes have low rejection or selectivity for cationic solutes.

To enhance the extreme acid and alkaline stability of the membranes, cases of utilizing selective layer materials other than polyamides have been reported. However, although these materials showed good stability in extremely acidic environments, they exhibited low stability in extremely alkaline environments. As such, there are no stable selective layer materials in extremely alkaline environments.

Therefore, in the present invention, Menshutkin polymerization is utilized to manufacture the selective layer of a thin-film composite membrane that is stable in both extremely acidic and alkaline environments. Menshutkin polymerization is a reaction in which a tertiary amine-based monomer and an alkyl halide-based monomer react to produce a crosslinked polymer with quaternary ammonium junction groups. The crosslinked quaternary ammonium structure can have high acid and alkaline stability because it lacks components vulnerable to hydrolysis, and because it has a positive surface charge, it can have high rejection and selectivity for cationic solutes.

### RELATED ART DOCUMENT

### Patent Document

1. Korea Patent Publication No. 10-2019-0114817

### DISCLOSURE

### Technical Problem

Existing polyamide-based thin-film composite membranes have the drawback of being hydrolyzed under extremely acidic and alkaline conditions, making them difficult to treat wastewater and effluent under extremely acid and alkaline conditions.

Therefore, the present invention is directed to manufacture a cross-linked quaternary ammonium-based thin-film composite membrane having excellent extreme acid and alkaline stability through the Menshutkin polymerization reaction, which has not been utilized in existing thin-film composite membranes for water treatment.

### Technical Solution

The present invention provides a method for manufacturing a thin-film composite membrane for water treatment, including forming a cross-linked quaternary ammonium polymer-based selective layer on a porous support and/or inside the pores of the porous support through Menshutkin polymerization.

In addition, the present invention provides a thin-film composite membrane for water treatment, including:
a porous support; and
a selective layer formed on one or both sides of the porous support and/or inside the pores of the porous support,
wherein the selective layer includes a cross-linked quaternary ammonium polymer formed on one or both sides of the porous support and/or inside the pores of the porous support through Menshutkin polymerization.

### Advantageous Effects

The thin-film composite membrane according to the present invention is a new material membrane, which is manufactured based on the cross-linked quaternary ammonium polymer having high hydrolysis resistance. Therefore, it can have excellent stability in both extremely acidic and alkaline environments. In addition, because the surface of the thin-film composite membrane according to the present invention is positively charged, it can have high rejection and selectivity for cationic solutes.

Therefore, the thin-film composite membrane according to the present invention can be used not only as separation membranes for water treatment, valuable metal resource recovery, sewage and wastewater treatment, and solvent purification, which require high acid and alkaline stability and high cation rejection/selectivity, but also as anion-conductive membranes for water electrolysis, fuel cell, electrodialysis.

### DESCRIPTION OF DRAWINGS

FIG. 1 is a schematic diagram showing a method for manufacturing a thin-film composite membrane through Menshutkin polymerization.

FIG. 2 is the surface images of the porous support and thin-film composite membrane manufactured in Example 1.

FIG. 3 is a cross-sectional image of the thin-film composite membrane manufactured in Example 1.

FIG. 4 is a graph showing the rejection performance of the membranes for monovalent and divalent cations.

FIGS. 5 and 6 are graphs showing the changes in the performance of the membranes as a function of the immersion time in extremely acidic and alkaline aqueous solutions.

FIG. 7 is images showing the structural changes of the membranes after 28 days of immersion in extremely acidic and alkaline aqueous solutions.

### BEST MODE

Meanwhile, each description and embodiment disclosed in the present invention may also be applied to other descriptions and embodiments. That is, all combinations of the various elements disclosed herein are within the scope of the present invention. In addition, it cannot be said that the scope of the present invention is limited by the specific descriptions described below.

When a part is said to “include” a component, this means that other components may be further included, not excluded, unless specifically stated otherwise.

Hereinafter, a method for manufacturing a thin-film composite membrane for water treatment of the present invention will be described in detail.

A method for manufacturing a thin-film composite membrane for water treatment includes forming a cross-linked quaternary ammonium polymer-based selective layer on a porous support and/or inside the pores of the porous support through Menshutkin polymerization.

The Menshutkin reaction is a reaction in which a tertiary amine-based monomer and an alkyl halide-based monomer react to form quaternary ammonium. Menshutkin polymerization according to the present invention refers to a reaction forming a cross-linked quaternary ammonium polymer through the Menshutkin reaction of multifunctional tertiary amine and alkyl halide monomers. When a highly cross-linked quaternary ammonium polymer-based selective layer is formed on a porous support and/or inside the pores of the porous support through Menshutkin polymerization, it can have excellent stability in both extremely acidic and alkaline environments. In addition, because the surface of the membrane is positively charged, it can have high rejection and selectivity for cationic solutes.

In the present invention, the porous support can support the selective layer and reinforce the mechanical strength of the membrane.

In one embodiment, the porous support may be a polyolefin, and a commercially available product may be used or the porous support may be synthesized.

The porous support may include, for example, one or more polymer components selected from the group consisting of polyethylene, polypropylene, polymethylpentene, polybutene-1, a polyolefin elastomer, polyisobutylene, ethylene propylene rubber, polysulfone, polyacetylene, polyisobutylene, polyvinylchloride, polytetrafluoroethylene, polyimide, polyphenylene sulfide, polyacrylonitrile, polyether sulfone, polystyrene, polydimethylsiloxane, polyvinyl fluoride, ethylene vinyl alcohol, polyvinyl alcohol, polybenzimidazole, polyvinyl pyrrolidone, polyetherimide, polyvinylidene fluoride, and polyetherether ketone.

In one embodiment, the porous support may have an average molecular weight of 10,000 to 5,000,000 g mol⁻¹, and a contact angle of 150 degrees or less.

In one embodiment, the porous support may have a thickness of 1 to 1,000 μm, 1 to 100 μm, or 10 to 70 μm. Excellent performance can be realized with a thin-film composite membrane within the above thickness range.

In one embodiment, the porous support can have an average pore size of 1 nm to 100 μm, 10 nm to 1 μm, or 10 to 500 nm. The pore size may be measured using a capillary flow porometer. In the above size range, it is possible to manufacture a uniform selective layer and provide a thin-film composite membrane having excellent water permeability.

In one embodiment, the porosity (void fraction) of the porous support may be 5 to 90%, 10 to 40%, or 10 to 30%. In the above range, the water permeability of a thin-film composite membrane is excellent, and the strength of the support is also excellent.

In the present invention, a step of hydrophilizing the porous support may be additionally performed before forming a cross-linked quaternary ammonium polymer-based selective layer on the porous support and/or inside the pores of the porous support.

Through the above hydrophilization, hydrophilicity can be imparted to a hydrophobic porous support. Hence, the formation of the selective layer on the support can be facilitated, and the water permeability of a resulting thin-film composite membrane can be improved.

In one embodiment, the hydrophilization may be applied on one side, both sides, or the inner surface of the pores of the porous support.

In one embodiment, the hydrophilization may be performed by one or more processes selected from the group consisting of plasma treatment, atomic layer deposition, chemical vapor deposition, inorganic coating, organic coating, and chemical oxidation. In the present invention, hydrophilization may be performed through plasma treatment.

Organic coating may be performed through a step of coating the porous support with an oligomeric or polymeric material containing hydrophilic functional groups such as hydroxyl, carboxyl, or amine. The oligomeric or polymeric material containing hydrophilic functional groups may be, for example, one or more selected from the group consisting of polyvinyl alcohol, ethylene vinyl alcohol, polydopamine, polyacrylic acid, polymethacrylic acid, polyethylene glycol, polypropylene glycol, polyetherimide, tannic acid, polyvinyl amine, poly(4-styrene sulfonic acid), poly(vinylsulfonic acid), polyethyleneimine, polyaniline, polybenzimidazole, polyvinylpyrrolidone, and cellulose-based polymers.

In one embodiment, to increase the stability of the organic coating, a cross-linking step may be additionally performed after performing the organic coating.

At this time, the cross-linking may be performed by utilizing one or more components selected from the group consisting of glyoxal, glutaraldehyde, epichlorohydrin, boric acid, maleic acid, citric acid, and tetraethyl orthosilicate.

In one embodiment, after performing the hydrophilization or cross-linking, a step of washing the hydrophilized porous support may be additionally performed. During the washing step, isopropyl alcohol, water, or a mixed solvent thereof may be used as a washing solvent.

In the present invention, the selective layer may be formed on the hydrophilized porous support and/or inside the pores of the hydrophilized porous support through a Menshutkin polymerization reaction. The above selective layer may be formed on one or both sides of the porous support, and additionally may be formed inside the pores thereof. When the selective layer is formed inside the pores of the porous support, the selective layer inside the pores of the porous support may have a pore-filling form.

In one embodiment, when the selective layer is formed on the porous support, the thickness of the selective layer may be 1 nm to 100 μm, 1 nm to 50 μm, 3 nm to 1 μm, or 5 to 500 nm.

In one embodiment, Menshutkin polymerization may be performed by an interfacial polymerization method, a slot coating method, a dip coating method, a spin coating method, a layer-by-layer method, or a spray coating method.

In one embodiment, the selective layer may be formed by sequentially impregnating or coating the porous support with the first solution containing a tertiary amine-based monomer and the second solution containing an alkyl halide-based monomer and performing the polymerization reaction between the monomers of the first and second solutions.

Specifically, in the impregnation or application of the first and second solutions, the first solution containing the tertiary amine-based monomer may be impregnated or applied first, and then the second solution containing the alkyl halide-based monomer may be impregnated or applied. Conversely, the second solution may be impregnated or applied first and then the first solution may be impregnated or applied. Alternatively, the first and second solutions may be impregnated or applied simultaneously.

In one embodiment, the solvents of the first and second solutions are different from each other and may not be miscible each other.

In one embodiment, the tertiary amine-based monomer is not particularly limited as long as it is a monomer containing the tertiary amine group capable of forming a cross-linked quaternary ammonium polymer as a reactant of Menshutkin polymerization. The tertiary amine-based monomer may, for example, contain two or more tertiary amine groups. When the tertiary amine-based monomer contains two or more tertiary amine groups, a cross-linked polymer can be easily formed by reacting with an alkyl halide monomer.

The tertiary amine-based monomer may be a monomer having a molecular weight in the range of 50 to 1,000,000 g mol⁻¹.

The tertiary amine-based monomer may include, for example, one or more selected from the group consisting of N,N,N′,N′-tetramethylmethylenediamine, N,N,N′,N′-tetramethylethylenediamine, N,N,N′,N″,N″-pentamethyldiethylenetriamine, 1,1,4,7,10,10-hexamethyltriethylenetetramine), tris[2-(dimethylamino)ethyl]amine, tris(dimethylamino)methane, tetramethyl-1,3-diaminopropane, N,N,N′,N′-tetramethyl-1,4-butanediamine, N,N,N′,N′-tetramethyl-1,6-hexamethylenediamine, 1,4-dimethylpiperazine, 1,4,7-trimethyl-1,4,7-triazacyclononane, 1,4,8,11-tetramethyl-1,4,8,11-tetraazacyclotetradecane, N,N,N′,N′-tetramethyl-1,4-phenylenediamine, N,N,N′,N′-tetramethyl-1,3-phenylenediamine, 4,4′-trimethylenebis(1-methylpiperidine), 1,4-bis(diphenylamino)benzene, 4,4′-bipyridyl, 4,4′-trimethylenedipyridine, hexamine, altretamine, and polyethyleneimine.

In one embodiment, the solvent of the first solution may be one or more selected from the group consisting of water, methanol, ethanol, propanol, butanol, acetone, ethyl acetate, isopropanol, tetrahydrofuran, dimethyl sulfoxide, dimethyl phthalate, diethyl phthalate, dibutyl phthalate, dimethyl formamide, N-methyl-2-pyrrolidone, acetophenone, acetonitrile, and chloroform.

In one embodiment, the alkyl halide-based monomer is not particularly limited as long as it is a monomer containing the alkyl halide group capable of forming a cross-linked quaternary ammonium polymer as a reactant of Menshutkin polymerization.

The alkyl halide-based monomer may contain two or more alkyl halide groups. When the alkyl halide-based monomer contains two or more alkyl halide groups, a cross-linked polymer can easily be formed by reacting with a tertiary amine-based monomer.

The alkyl halide-based monomer may be a monomer having a molecular weight in the range of 50 to 1,000,000 g mol⁻¹.

The alkyl halide-based monomer may be, for example, one or more selected from the group consisting of 1,2-dichloroethane, 1,3-dichloropropane, 1,3-dibromopropane, 1,4-dichlorobutane, 1,4-dibromobutane, 1,4-diiodobutane, 1,6-dichlorohexane, 1,2-bis(bromomethyl)benzene, 1,3-bis(bromomethyl)benzene, 1,4-bis(bromomethyl)benzene, 1,3,5-tris(bromomethyl)benzene, 2,6-bis(bromomethyl)naphthalene, and 1,4-bis(1,2-dibromoethyl)benzene.

In one embodiment, the solvent of the second solution may be one or more selected from the group consisting of n-hexane, pentane, heptane, octane, decane, dodecane, cyclohexane, benzene, carbon tetrachloride, toluene, xylene, chloroform, tetrahydrofuran, N-methyl-2-pyrrolidone, acetophenone, acetonitrile, dimethyl phthalate, diethyl phthalate, dibutyl phthalate, dimethylformamide, and isoparaffin.

In one embodiment, when the miscibility between the solvents of the first and second solutions increases during interfacial polymerization, a thin-film composite membrane in which the selective layer is in a form of filling the pores of the porous support may be manufactured.

The present invention also relates to a thin-film composite membrane for water treatment, including:
a porous support; and
a selective layer formed on one or both sides of the porous support and/or inside the pores of the porous support,
wherein the selective layer includes a cross-linked quaternary ammonium polymer formed on one or both sides of the porous support and/or inside the pores of the porous support through Menshutkin polymerization.

In one embodiment, the selective layer may be formed on one side or both sides of the porous support. Alternatively, the selective layer may be formed inside the pores of the porous support. Alternatively, the selective layer may be formed on one side and inside the pores of the porous support, or on both sides and inside the pores of the porous support.

The thin-film composite membrane according to the present invention may be manufactured by the above-described method for manufacturing a thin-film composite membrane. Because the thin-film composite membrane according to the present invention is manufactured based on the cross-linked quaternary ammonium polymer with high hydrolysis resistance, the thin-film composite membrane can have excellent stability under both extremely acidic and alkaline conditions. In addition, because the surface of the thin-film composite membrane according to the present invention is positively charged, it can have high rejection and selectivity for cationic solutes. In addition, because the selective layer is formed through an interfacial reaction between two monomers dissolved in two mutually immiscible solvents, a uniform and highly dense selective layer can be produced.

The contents of the thin-film composite membrane of the present invention may be applied in the same manner as in the above-described contents of the method for manufacturing a thin-film composite membrane.

In one embodiment, the thin-film composite membrane for water treatment may satisfy one or more, two or more, three or more, or all of the following conditions (1) to (6). At this time, the filtration conditions are the same as those of Experimental Example 4, and the filtration test may be performed at a flow rate of 0.5 L min⁻¹, a pressure of 10 bar, and a temperature of 25° C., and performed with 1,000 ppm of magnesium chloride (MgCl₂) and 1,000 ppm of organic solutes (polyethylene glycol, molecular weight 400 g mol⁻¹ [PEG400]).
(1) after exposing the thin-film composite membrane for water treatment to a 1.5 M sulfuric acid aqueous solution, MgCl₂ rejection is 90% or more, particularly, 97% or more after 28 days of exposure, and PEG400 rejection is 80% or more,
(2) after exposing the thin-film composite membrane for water treatment to a 5 M sodium hydroxide aqueous solution, MgCl₂ rejection is 90% or more, particularly, 97% or more after 28 days of exposure, and PEG400 rejection is 80% or more,
(3) after exposing the thin-film composite membrane for water treatment to a 1.5 M sulfuric acid aqueous solution, the changes in MgCl₂ and PEG400 rejection after 28 days of exposure are 10% or less,
(4) after exposing the thin-film composite membrane for water treatment to a 5 M sodium hydroxide aqueous solution, the changes in MgCl₂ and PEG400 rejection after 28 days of exposure are 10% or less,
(5) after exposing the thin-film composite membrane for water treatment to a 1.5 M sulfuric acid aqueous solution, the change in water flux after 28 days of exposure is 10% or less, and
(6) after exposing the thin-film composite membrane for water treatment to a 5 M sodium hydroxide aqueous solution, the change in water flux after 28 days of exposure is 10% or less.

Hereinafter, preferred examples and experimental examples are presented to aid understanding of the present invention. However, the following examples and experimental examples are only provided to more easily understand the present invention, and the content of the present invention is not limited by the following examples and experimental examples.

### MODES OF THE INVENTION

### Examples

### Example 1

### 1) Manufacture of the Porous Support

Polyethylene with a thickness of 20 μm was used as a porous support.

The above polyethylene support was hydrophilized by plasma treatment as follows.

\textcircled{1} The polyethylene support was mounted in the plasma equipment.

\textcircled{2} The polyethylene support was irradiated with plasma at a pressure of 0.09 kPa and an intensity of 10 W for 90 seconds in an oxygen atmosphere.

### 2) Manufacture of the Selective Layer

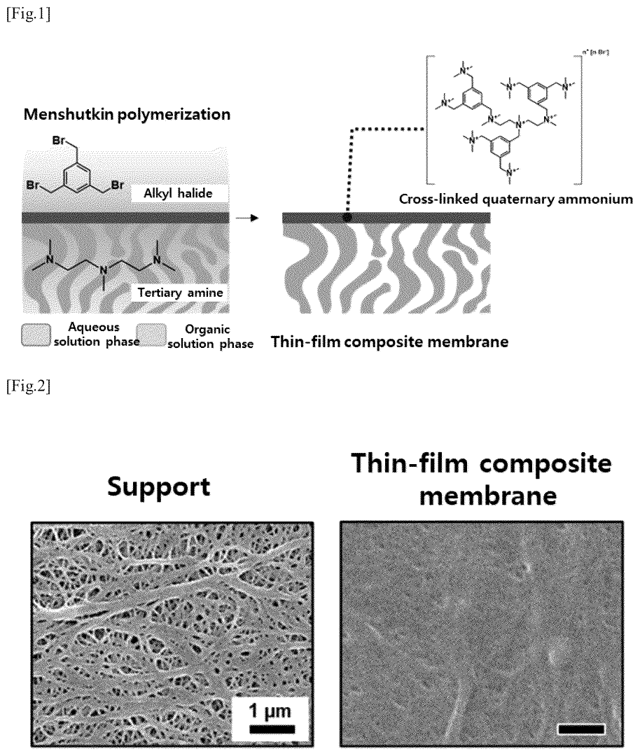

FIG. 1 is a schematic diagram showing a method for manufacturing a thin-film composite membrane using Menshutkin polymerization.

In the present invention, as shown in FIG. 1, a selective layer including a cross-linked quaternary ammonium polymer can be formed on a porous support through Menshutkin polymerization. Specifically, Menshutkin polymerization can be performed through interfacial polymerization, which is a polymerization reaction occurring at the interface between the monomers dissolved in two immiscible solvents (water/organic solvent).

The first solution, which is an aqueous solution, was prepared by dissolving 100 g L⁻¹ of N,N,N′,N″,N″-pentamethyldiethylenetriamine, which is a tertiary amine-based monomer, in water as a solvent. In addition, the second solution, which is an organic solution, was prepared by dissolving 1 g L⁻¹ of 1,3,5-tris(bromomethyl)benzene, which is an alkyl halide monomer, in n-hexane as a solvent.

The selective layer was manufactured through the Menshutkin interfacial polymerization method as follows.

\textcircled{1} The hydrophilized support was immersed in the first solution for 30 minutes.

\textcircled{2} The immersed membrane was taken out, an excess solution on the surface was appropriately removed with a roller, and then the resulting membrane was immersed in the second solution and allowed to react at room temperature for 24 hours.

\textcircled{3} After the reaction, the membrane was taken out, the solution remaining on the surface was washed with n-hexane, and the resulting membrane was dried at room temperature for 5 minutes.

\textcircled{4} The membrane was dried in an oven at 70° C. for 5 minutes to further react unreacted monomers.

\textcircled{5} The manufactured membrane was immersed in a 2 M potassium hydroxide aqueous solution for 1 hour or more to exchange the bromo ions (Br) generated after the reaction with hydroxide ions (OH⁻).

### Comparative Example A

A polyamide-based thin-film composite membrane (Comparative Example A) prepared through interfacial polymerization between MPD and TMC on the hydrophilized polyethylene support was used.

### Comparative Example B

A polyamide-based thin-film composite membrane (Comparative Example B) prepared through interfacial polymerization between PIP and TMC on the hydrophilized polyethylene support was used.

### Comparative Example C

The NP030 membrane (Comparative Example C) provided by Microdyn-Nadir, which is a commercial acid and alkali-resistant membrane for water treatment, was used.

### Experimental Example 1. Observation of the Structure of the Thin-Film Composite Membrane

The surface and cross-sectional structures of the porous support and thin-film composite membrane manufactured in Example 1 were analyzed using a scanning electron microscope (SEM).

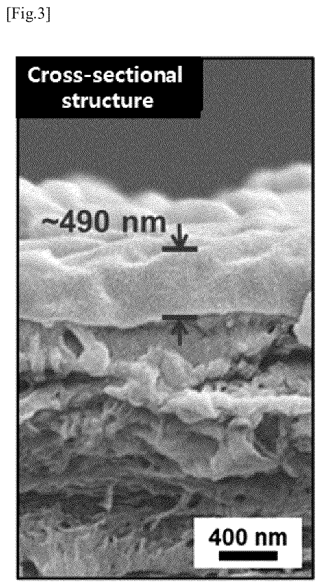

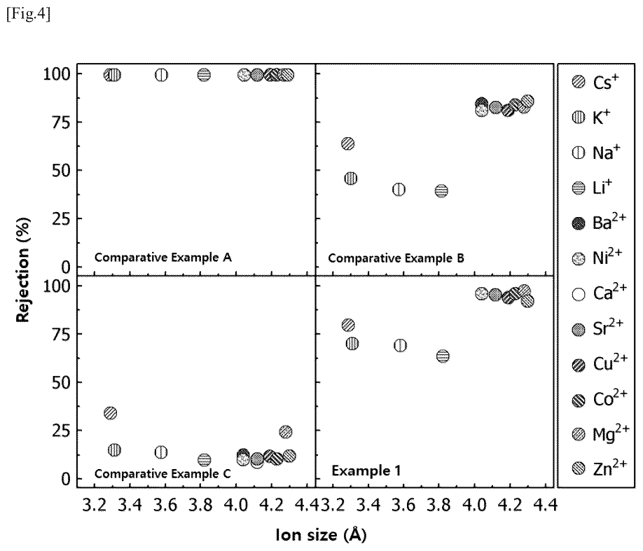

FIG. 2 shows the surface structure of the porous support and thin-film composite membrane manufactured in Example 1. In addition, FIG. 3 shows the cross-sectional structure of the thin-film composite membrane manufactured in Example 1.

As shown in FIG. 2, it can be confirmed that a selective layer is synthesized on a hydrophilized support to form a thin-film composite membrane because the surface pores of the support are completely blocked with the selective layer. The formation of the selective layer can also be confirmed from the cross-sectional structure of the membrane, where the selective layer sitting on the porous support is clearly observed.

### Experimental Example 2. Confirmation of the Positive Surface Charge Characteristics of the Thin-Film Composite Membrane

The surface charge of the membranes of the example and comparative examples was measured using a zeta potential analyzer in an aqueous solution containing 10 mM sodium chloride (NaCl) and having a pH of 5.8.

The results of the surface charge measurement of the membranes are shown in Table 1 below.

TABLE 1

| | Surface zeta potential @ pH |
|---|---|
| Membrane | 5.8 (mV) |
| Comparative Example A | −9.9 ± 5.6 |
| Comparative Example B | −1.1 ± 0.8 |
| Comparative Example C | −32.0 ± 1.2 |
| Example 1 | 28.3 ± 1.5 |

As shown in the above table, it can be confirmed that the thin-film composite membrane of Example 1 has a positive surface charge, unlike the polyamide-based and commercial pH-resistant membranes of the comparative examples.

The thin-film composite membrane according to the present invention exhibits a positive surface charge, and thus can have high rejection and selectivity for cationic solutes.

### Experimental Example 3. Performance Evaluation of the Thin-Film Composite Membrane

The performance of the membranes was evaluated using a crossflow filtration equipment.

Specifically, under the filtration test conditions of a flow rate of 0.5 L min⁻¹, a pressure of 10 bar, and a temperature of 25° C., the water flux and cation rejection of the membranes were evaluated using aqueous feed solutions containing 1,000 ppm cations, such as monovalent cations [cesium chloride (CsCl), potassium chloride (KCl), NaCl, and lithium chloride (LiCl)] and divalent cations [barium chloride (BaCl₂), nickel chloride (NiCl₂), calcium chloride (CaCl₂), strontium chloride (SrCl₂), copper chloride (CuCl₂), cobalt chloride (CoCl₂), MgCl₂, and zinc chloride (ZnCl₂)]. The monovalent/divalent cation selectivity of the membranes of the example and comparative examples was calculated as divalent cation (MgCl₂) rejection relative to monovalent cation (LiCl) rejection.

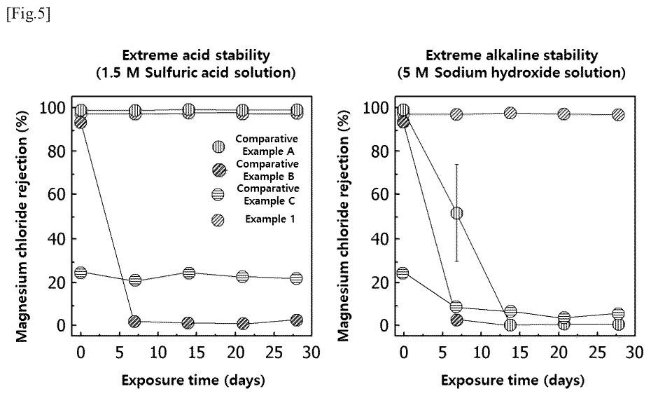

The results of the performance measurement of the membranes are shown in Tables 2 and 3 and FIG. 4.

TABLE 2

| Membrane | Water flux (L m⁻² h⁻¹) |
|---|---|
| Comparative Example A | 27 ± 2 |
| Comparative Example B | 60 ± 6 |
| Comparative Example C | 18 ± 1 |
| Example 1 | 29 ± 4 |

TABLE 3

| | Monovalent/divalent |
|---|---|
| Membrane | cation selectivity |
| Comparative Example A | 1.2 |
| Comparative Example B | 3.5 |
| Comparative Example C | 1.2 |
| Example 1 | 8.1 |

As shown in Tables 2 and 3 and FIG. 4, it can be confirmed that the thin-film composite membrane of Example 1 exhibits a high level of water flux and high rejection for divalent cations despite somewhat low rejection for monovalent cations due to its high positive surface charge.

In addition, when compared with the polyamide-based and commercial pH-resistant membranes of the comparative examples, it can be confirmed that the manufactured thin-film composite membrane has higher monovalent/divalent cation selectivity due to its positively charged surface characteristics. Through this, the thin-film composite membrane of the present invention can be utilized in processes for recovering valuable metals that require high cation selectivity.

### Experimental Example 4. Extreme Acid and Alkaline Stability Assessment

The membranes of the example and comparative examples were immersed in the extremely acidic (1.5 M sulfuric acid) or alkaline (5 M sodium hydroxide) aqueous solution, and then the changes in their performance as a function of the immersion (exposure) time were monitored by evaluating their water flux and MgCl₂ and organic solute (PEG400) rejection using aqueous feed solutions containing 1,000 ppm MgCl₂ and PEG400 under the filtration conditions of a flow rate of 0.5 L min⁻¹, a pressure of 10 bar, and a temperature of 25° C.

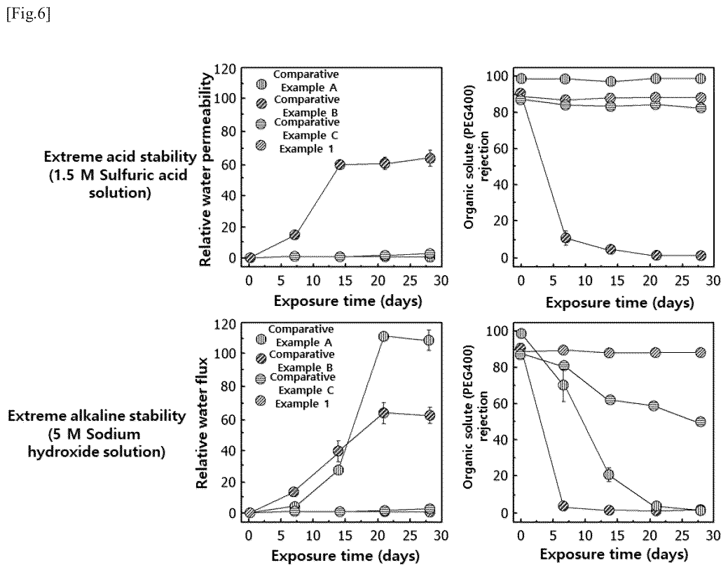

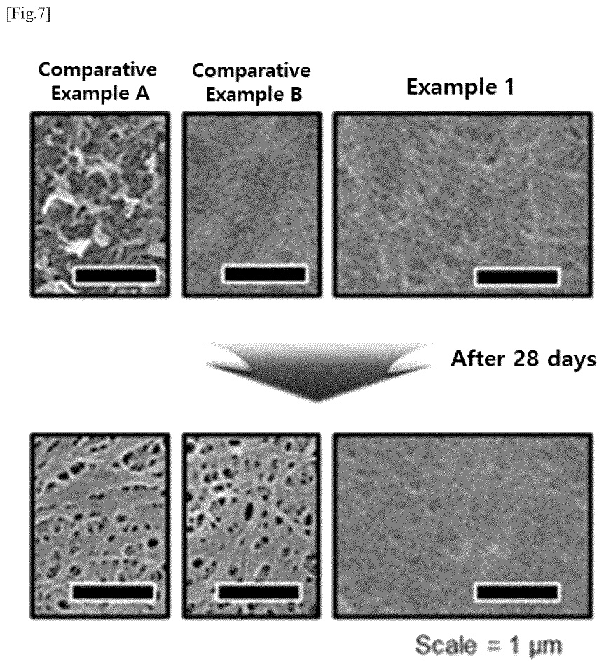

FIGS. 5 and 6 show the changes in the performance of the membranes as a function of the immersion time in extremely acidic and alkaline aqueous solutions. In addition, FIG. 7 shows the structural changes of the membranes after 28 days of immersion in extremely acidic and alkaline aqueous solutions.

As shown in FIGS. 5 to 7, it can be confirmed that the performance of the polyamide-based membrane of Comparative Examples B remarkably deteriorates in both extremely acidic and alkaline aqueous solutions and completely decompose after 28 days. It can also be confirmed that, the polyamide-based membrane of Comparative Examples A and commercial pH-resistant membrane of Comparative Example C exhibit stable performance under extremely acidic conditions, but decompose under extremely alkaline conditions.

On the other hand, it can be confirmed that the thin-film composite membrane of Example 1, unlike the membranes of the comparative examples, does not show any change in performance and structure even when exposed to both extremely acidic and alkaline environments for 28 days.

Through this, it can be confirmed that the thin-film composite membrane manufactured through Menshutkin polymerization has excellent extreme acid and alkaline stability, and thus can replace the existing polyamide-based membrane when feed solutions are extremely acidic or alkaline.

### INDUSTRIAL APPLICABILITY

The thin-film composite membrane according to the present invention is a new material membrane, which is manufactured based on a cross-linked quaternary ammonium polymer having high hydrolysis resistance. Therefore, it can have excellent stability in both extremely acidic and alkaline environments. In addition, because the surface of the thin-film composite membrane according to the present invention is positively charged, it can have high rejection and selectivity for cationic solutes.

Therefore, the thin-film composite membrane according to the present invention can be used not only as separation membranes for water treatment, valuable metal resource recovery, sewage and wastewater treatment, and solvent purification, which require high acid and alkaline stability and high cation rejection/selectivity, but also as anion-conductive membranes for water electrolysis, fuel cell, electrodialysis.

1. A method for manufacturing a thin-film composite membrane for water treatment, including forming a cross-linked quaternary ammonium polymer-based selective layer on a porous support and/or inside the pores of the porous support through Menshutkin polymerization.

2. The method of claim 1, wherein the porous support includes one or more polymer components selected from the group consisting of polyethylene, polypropylene, polymethylpentene, polybutene-1, a polyolefin elastomer, polyisobutylene, ethylene propylene rubber, polysulfone, polyacetylene, polyisobutylene, polyvinylchloride, polytetrafluoroethylene, polyimide, polyphenylene sulfide, polyacrylonitrile, polyether sulfone, polystyrene, polydimethylsiloxane, polyvinyl fluoride, ethylene vinyl alcohol, polyvinyl alcohol, polybenzimidazole, polyvinyl pyrrolidone, polyetherimide, polyvinylidene fluoride, and polyetherether ketone.

3. The method of claim 1, wherein the porous support has a thickness of 1 to 1,000 μm, an average pore size of 1 nm to 100 μm, and a porosity of 5 to 90%.

4. The method of claim 1, wherein the hydrophilization of the porous support may be additionally performed prior to forming the cross-linked quaternary ammonium polymer-based selective layer on the porous support and/or inside the pores of the porous support.

5. The method of claim 4, wherein the hydrophilization of the porous support is performed by one or more processes selected from the group consisting of plasma treatment, atomic layer deposition, chemical vapor deposition, inorganic coating, organic coating, and chemical oxidation.

6. The method of claim 5, wherein the organic coating is coating the porous support with one or more polymer components selected from the group consisting of polyvinyl alcohol, ethylene vinyl alcohol, polydopamine, polyacrylic acid, polymethacrylic acid, polyethylene glycol, polypropylene glycol, polyetherimide, tannic acid, polyvinyl amine, poly(4-styrene sulfonic acid), poly(vinylsulfonic acid), polyethyleneimine, polyaniline, polybenzimidazole, polyvinylpyrrolidone, and cellulose-based polymers.

7. The method of claim 1, wherein Menshutkin polymerization is performed by an interfacial polymerization method, a slot coating method, a dip coating method, a spin coating method, a layer-by-layer method, or a spray coating method.

8. The method of claim 1, wherein the selective layer is formed by sequentially impregnating or coating the porous support with the first solution containing a tertiary amine-based monomer and the second solution containing an alkyl halide-based monomer and performing a polymerization reaction between the monomers of the first and second solutions.

9. The method of claim 8, wherein
the tertiary amine-based monomer is a monomer containing two or more tertiary amine groups and having a molecular weight of 50 to 1,000,000 g mol⁻¹, and
the alkyl halide-based monomer is a monomer containing two or more alkyl halide groups and having a molecular weight of 50 to 1,000,000 g mol⁻¹.

10. The method of claim 8, wherein the tertiary amine-based monomer includes one or more selected from the group consisting of N,N,N′,N′-tetramethylmethylenediamine, N,N,N′,N′-tetramethylethylenediamine, N,N,N′,N″,N″-pentamethyldiethylenetriamine, 1,1,4,7,10,10-hexamethyltriethylenetetramine), tris[2-(dimethylamino)ethyl]amine, tris(dimethylamino)methane, tetramethyl-1,3-diaminopropane, N,N,N′,N′-tetramethyl-1,4-butanediamine, N,N,N′,N′-tetramethyl-1,6-hexamethylenediamine, 1,4-dimethylpiperazine, 1,4,7-trimethyl-1,4,7-triazacyclononane, 1,4,8,11-tetramethyl-1,4,8,11-tetraazacyclotetradecane, N,N,N′,N′-tetramethyl-1,4-phenylenediamine, N,N,N′,N′-tetramethyl-1,3-phenylenediamine, 4,4′-trimethylenebis(1-methylpiperidine), 1,4-bis(diphenylamino)benzene, 4,4′-bipyridyl, 4,4′-trimethylenedipyridine, hexamine, altretamine, and polyethyleneimine.

11. The method of claim 8, wherein the solvent of the first solution is one or more selected from the group consisting of water, methanol, ethanol, propanol, butanol, acetone, ethyl acetate, isopropanol, tetrahydrofuran, dimethyl sulfoxide, dimethyl phthalate, diethyl phthalate, dibutyl phthalate, dimethyl formamide, N-methyl-2-pyrrolidone, acetophenone, acetonitrile, and chloroform.

12. The method of claim 8, wherein the alkyl halide-based monomer is one or more selected from the group consisting of 1,2-dichloroethane, 1,3-dichloropropane, 1,3-dibromopropane, 1,4-dichlorobutane, 1,4-dibromobutane, 1,4-diiodobutane, 1,6-dichlorohexane, 1,2-bis(bromomethyl)benzene, 1,3-bis(bromomethyl)benzene, 1,4-bis(bromomethyl)benzene, 1,3,5-tris(bromomethyl)benzene, 2,6-bis(bromomethyl)naphthalene, and 1,4-bis(1,2-dibromoethyl)benzene.

13. The method of claim 8, wherein the solvent of the second solution is one or more selected from the group consisting of n-hexane, pentane, heptane, octane, decane, dodecane, cyclohexane, benzene, carbon tetrachloride, toluene, xylene, chloroform, tetrahydrofuran, N-methyl-2-pyrrolidone, acetophenone, acetonitrile, dimethyl phthalate, diethyl phthalate, dibutyl phthalate, dimethylformamide, and isoparaffin.

14. A thin-film composite membrane for water treatment, including:
a porous support; and
a selective layer formed on one or both sides of the porous support and/or inside the pores of the porous support,
wherein the selective layer includes a cross-linked quaternary ammonium polymer formed on one or both sides of the porous support and/or inside the pores of the porous support through Menshutkin polymerization.

15. The thin-film composite membrane of claim 14, wherein the porous support is hydrophilized.

16. The thin-film composite membrane of claim 14, satisfying one or more of the conditions (1) to (6):
(1) after exposing the thin-film composite membrane for water treatment to a 1.5 M sulfuric acid aqueous solution, magnesium chloride rejection is 90% or more after 28 days of exposure, and polyethylene glycol (molecular weight 400 g mol⁻¹) rejection is 80% or more,
(2) after exposing the thin-film composite membrane for water treatment to a 5 M sodium hydroxide aqueous solution, magnesium chloride rejection is 90% or more after 28 days of exposure, and polyethylene glycol (molecular weight 400 g mol⁻¹) rejection is 80% or more,
(3) after exposing the thin-film composite membrane for water treatment to a 1.5 M sulfuric acid aqueous solution, the changes in magnesium chloride and polyethylene glycol (molecular weight 400 g mol⁻¹) rejection after 28 days of exposure are 10% or less,
(4) after exposing the thin-film composite membrane for water treatment to a 5 M sodium hydroxide aqueous solution, the changes in magnesium chloride and polyethylene glycol (molecular weight 400 g mol⁻¹) rejection after 28 days of exposure are 10% or less,
(5) after exposing the thin-film composite membrane for water treatment to a 1.5 M sulfuric acid aqueous solution, the change in water flux after 28 days of exposure is 10% or less, and
(6) after exposing the thin-film composite membrane for water treatment to a 5 M sodium hydroxide aqueous solution, the change in water flux after 28 days of exposure is 10% or less.
